(19) United States
(12) Patent Application Publication
(10) Pub. No.: US 2004/0145587 A1
(43) Pub. Date: Jul. 29, 2004

(54) Shape processor, three-dimensional shape encoding method

(76) Inventor: Naoto Morikawa, Kanagawa (JP)

Correspondence Address: EDWARDS & ANGELL, LLP, P.O. BOX 55874, BOSTON, MA, 02205, US

(21) Appl. No.: 10/730,526

(22) Filed: Dec. 5, 2003

Related U.S. Application Data
(63) Continuation of application No. PCT/JP02/05606, filed on Jun. 6, 2002.

(30) Foreign Application Priority Data
Jun. 8, 2001 (JP) JP 2001-212811

(51) Int. Cl. G06T 11/20

(52) U.S. Cl. 345/441

(57) ABSTRACT

A shape processor for imitating the shape of an object in a three-dimensional space. The shape processor comprises a reference information acquiring unit for acquiring reference body information for specifying the shape of a reference body which is a tetrahedron composed of four identical faces, side setting information for setting two sides of said reference body in a twisted position as first and second sides, and face setting information for setting two faces sharing said first side of said reference body as first and second faces, an approximating unit for imitating the shape of an object using said reference bodies by putting said first side of said first reference body on said second side of said second reference body and putting either said first or second face of said first reference body on the corresponding face of said second reference body, according to the information representing the shape of the object and the information acquired by said reference information acquiring unit, and an approximation information storage unit for storing approximation information representing which of said first and second faces of said first reference body is put on the corresponding face of said second reference body.

The present application is a continuation application of PCT/JP02/05606 filed on Jun. 6, 2002 which claims priority from Japanese Patent Application No. 2001-212811 filed on Jun. 8, 2001, the contents of which are incorporated herein by reference.

### BACKGROUND OF THE INVENTION

1. Field of the Invention

This invention relates to shape processors which imitate the shape of a given object in a three-dimensional space and reproduce it, computer programs used for shape processing, shape coding methods which encode the shape of an object utilizing relations among the reference blocks obtained by dividing of the shape.

2. Related Art

So far, it is known that the tetrahedrons which consist of such four triangles that the ratio of the sides is 2:sqrt (3):sqrt (3) can be fitted together to fill a three-dimensional space without overlaps and gaps (G. Nakamura, sinsho-427 ‘Mathematical puzzles’, Chuo Kouron-sha, 1976). Here we use sqrt (3) to denote the square root of 3. And it is also known that, using the tetrahedrons as building blocks, one can construct various kinds of figures. In particular, a rhombic dodecahedron is obtained by putting twenty-four tetrahedrons together. Note that the tetrahedrons are considered separately in the construction. That is, there is no particular relation among the tetrahedrons.

As representation methods of the shape of a three-dimensional object, the followings are well known and fundamental.

First, there is a method which imitates the surface of a object using polygons (polygon-mesh) and represents the surface by the vertices, edges and faces of polygons. To represent the surface of a object which is not smooth-faced, a patch of pieces of curved surfaces is also used in some methods.

In the case of polygon-mesh, since multiple polygons share a vertex, a naive description of the polygon-mesh is accompanied by a frequent recurrence of one vertex. To save the redundancy, various methods are proposed.

For example, in the case of triangle-mesh, there is the marching pattern method that describes the arrangement of triangles efficiently. In the method triangles are arranged in a line to form a sash and each triangle tile is assigned a value 0 or 1 which denotes the side of the sash covered by the tile as disclosed, for example, in G. Taubin and J. Rossignac: Geometry Compression through Topological Surgery, ACM Transactions on Graphics, 17(2), pp. 84-115 (1998).

Second, there is another method that imitates the surface of an object using reference blocks, such as cuboids, spheres and cylinders. The method is known as the Constructive Solid Geometry (CSG) method. The position of a reference block is usually described using a tree structure. That is, every node in the tree structure stands for coordinates of a position, every branch in the tree structure stands for a coordinate transformation and every leaf in the tree structure stands for a reference block. To draw the object, one begins with the top node and descending down the tree to a leaf along the shortest path, executing transformations whenever it passes a branch. Then, at a leaf, one has obtained the actual coordinates of the object, as disclosed, for example, in A. S. Glassner, 3D COMPUTER GRAFHICS A User's Guide for Artists and Designers 2^{nd} ed.: TAB BOOKS (A Division of McGraw-Hill), 1989.

Now we illustrate the polygon-mesh method and the CSG method. For simplicity, we only explain the case of two-dimensional objects. The case of three-dimensional objects is the same.

First, suppose that we are given a figure P of FIG. 17. In the polygon-mesh method the outline of a figure is described as a broken line. In this case, P consists of ten segments as shown in FIG. 18. The broken line is represented by arranging the (x, y)-coordinates of the starting points and ending points of the segments as in FIG. 19 to avoid redundant description of points. In the case of three-dimensional objects, one imitates the surface of an object using polygons instead of segments. And various data structures are proposed for efficient representation of the polygons.

On the other hand, in the CSG method, one should choose reference blocks in advance. Here we select four kinds of blocks, pentagon, triangle, square and rectangle, as shown in FIG. 20. Using these blocks, the figure P of FIG. 17 is divided into six reference blocks, A (pentagon), B (triangle), C (square), D (triangle), E (rectangle) and F (pentagon), as shown in FIG. 21.

We use a tree structure to represent the relation among the blocks as shown in the table of FIG. 22 (When, instead of a table, one uses a script, such as model description languages, to describe the relation, there also exists the same kind of a structure behind the description.).

An entry of the table contains data of entry-name, node-type, block-type, entry-names of its descendents and transformation-information such as translation-vector, rotation-angle and enlargement-factor.

Data of an entry are divided into two groups. One is data of the node itself, such as node-type such as root, branch or leaf and block-type such as pentagon, triangle, square, etc.

The other is data of its descendents (child-nodes), such as entry-names of the descendents and their relative positions with respect to the coordinate-system of the node, i.e., the positions with respect to the node. For example, the figure of FIG. 17 is obtained by processing the nodes of FIG. 22 from node F to node A as is shown in FIG. 23.

Now we go into details about it. First, the block-type of node F is pentagon and F has no descendents since it is a leaf. Therefore we obtain the figure of FIG. 23(f).

Second, the block-type of node E is rectangle and E has F as its child-node. To obtain the position of the child-node F we first translate a rectangle by the vector (2, 1) and then rotate it counter-clockwise by 90 degrees. Note that the size of F is the same as the basic block because its enlargement-factor is equal to 1. And we obtain the figure of FIG. 23(e).

In the same way as above, block-type of node D is triangle and D has the child-node E. To obtain the position of E we first translate a rectangle by the vector (−1, 1). Note that the size of E is the same as the basic block. Now we obtain the figure of FIG. 23(d).

Continuing the process until node Root is encountered, we obtain the figure of FIG. 23(r).

Next we illustrate the marching pattern method using the figure of FIG. 24. The coordinates of vertices are given in the table of FIG. 25. In this method, we use values of 0 and 1 to specify the existence of a side between two vertices (topological information).

First of all, we describe the vertices of the initial triangle t0t1t2. Each vertex is associated with a value of topological information, that is, 0 if the vertex in on the right side of the sash and 1 if on the left side. In this case, we assign 0 to t1 and 1 to t2.

Next, we describe the vertex t3 of the consecutive triangle t1t2t3 and assign it 1 as topological information.

Continuing the process until the final triangle is encountered, we obtain the table of FIG. 25.

Then sides of triangles between the vertices of topological information 0 give the right side of the sash. In the same way, sides between the vertices of value 1 give the left side of the sash. Note that, changing topological information of t3 from 1 to 0, we obtain another figure of FIG. 26.

So far we have shown various methods and instruments similar to the invention. In the following we show their known faults.

When one forms a rhombic dodecahedron by combining tetrahedrons, it is tedious to describe how to combine them.

When one represents the shape of a three-dimensional object by a polygon-mesh, one should describe every vertex since any type of triangle is to be used. But it is an over-specification if one concerns only with the shape of an object. For example, a shape is invariant under translations and rotations.

When one describe a shape by the CSG method, a tree-like structured description is required to store the position of each reference block used. It is also an over-specification if one concerns only with a shape. In particular, no need for the coordinates of the position of the blocks.

Moreover, in each case mentioned above, one takes all external boundary of every polygon (or reference block) into account, which complicate the description of the shape.

Therefore, it is among the objects of this invention to provide shape processors, computer programs used for shape processing, and shape coding methods which imitate the shape of an object in a three-dimensional space by a simple description of relative position of tetrahedrons which dose not depend on coordinates, and require no advanced knowledge to reproduce the shape.

### SUMMARY OF THE INVENTION

In accordance with the first embodiment of this invention, a shape processor for imitating the shape of a given object in a three-dimensional space comprises a reference information acquiring unit, an approximating unit and an approximation information storage unit.

The reference information acquiring unit acquires reference body information, side setting information and face setting information. Reference body information specifies the shape of a reference body which is a tetrahedron composed of four identical faces. Side setting information sets two sides of the reference body in a twisted position as first and second sides. Face setting information sets two faces sharing the first side of the reference body as first and second faces.

The approximating unit imitates the shape of an object using reference bodies. The approximating unit puts a first side of a first reference body on a second side of a second reference body and then puts either a first or second face of the first reference body on the corresponding face of the second reference body, according to according to the information of the shape of the object and the information acquired by the reference information acquiring unit.

The approximation information storage unit stores approximation information. Approximation information represents which of the first and second faces of the first reference body is put on the corresponding face of the second reference body.

In accordance with the second embodiment of this invention, a shape processor for reproducing the shape of a given object in a three-dimensional space comprises a reference information acquiring unit, an approximation information storage unit and a reproducing unit.

The reference information acquiring unit acquires reference body information, side setting information and face setting information. Reference body information specifies the shape of a reference body which is a tetrahedron composed of four identical faces. Side setting information sets two sides of the reference body in a twisted position as first and second sides. Face setting information sets two faces sharing the first side of the reference body as first and second faces.

The approximation information storage unit acquires approximation information. Approximation information represents which of the first and second faces of the first reference body is put on the corresponding face of the second reference body.

The reproducing unit reproduces the shape of an object using reference bodies. The reproducing unit puts a first side of a first reference body on a second side of another reference body and then puts either a first or second face of the first reference body on the corresponding face of another reference body, according to according to the information acquired by the reference information acquiring unit and the approximation information acquired by the approximation information storage unit.

It is preferred that the reference information acquiring unit acquires reference body information which specifies a tetrahedron composed of four identical faces which are such isosceles triangles that the ratio of length of its sides is 2:sqrt (3):sqrt (3).

In accordance with the third embodiment of this invention, a shape processing program for approximating the shape of a given object in a three-dimensional space comprises a reference information acquiring module, an approximating module and an approximation information storage module.

The reference information acquiring module acquires reference body information, side setting information and face setting information. Reference body information specifies the shape of a reference body which is a tetrahedron composed of four identical faces. Side setting information sets two sides of the reference body in a twisted position as first and second sides. Face setting information sets two faces sharing the first side of the reference body as first and second faces.

The approximating module imitates the shape of an object using reference bodies. The approximating module puts a first side of a first reference body on a second side of a second reference body and then puts either a first or second face of the first reference body on the corresponding face of the second reference body, according to the information of the shape of the object and the information acquired by the reference information acquiring module.

The approximation information storage module stores approximation information. Approximation information represents which of the first and second faces of the first reference body is put on the corresponding face of the second reference body.

In accordance with the fourth embodiment of this invention, a shape processing program for reproducing the shape of a given object in a three-dimensional space comprises a reference information acquiring module, an approximation information storage module and an reproducing module.

The reference information acquiring module acquires reference body information, side setting information and face setting information. Reference body information specifies the shape of a reference body which is a tetrahedron composed of four identical faces. Side setting information sets two sides of the reference body in a twisted position as first and second sides. Face setting information sets two faces sharing the first side of the reference body as first and second faces.

The approximation information storage module acquires approximation information. Approximation information represents which of the first and second faces of the first reference body is put on the corresponding face of the second reference body.

The reproducing module reproduces the shape of an object using reference bodies. The reproducing module puts a first side of a first reference body on a second side of another reference body and then puts either a first or second face of the first reference body on the corresponding face of another reference body, according to the information acquired by the reference information acquiring module and the approximation information acquired by the approximation information storage module.

In accordance with the second embodiment of this invention, a shape encoding method encodes the shape of a given object in a three-dimensional space by representing the relation among reference bodies obtained by dividing the object.

In the method the shape is encoded into a sequence of 0 and 1 using reference bodies where each reference body is a tetrahedron composed of such four identical isosceles triangles that the ratio of length of its sides is 2:sqrt (3):sqrt (3). Each reference body is connected with another one or two reference bodies to form a chain. They are connected at the longer edges in such a way that two faces of a reference body can be brought into contact with the corresponding faces of the following reference body, one pair at a time, by rotation around the longer edge shared by the two reference bodies.

The shape is encoded by specifying the folding of the chain, i.e., the folding at each longer edge between two consecutive reference bodies in the chain. The values of 0 and 1 are assigned to the two faces of a reference body which share a longer edge, 0 for a face and 1 for the other, in advance. The values are used to describe the folding at the longer edges, that is, which face of the reference body is in contact with the corresponding face of the following reference body.

In a preferred embodiment, the sequence of the values 0 and 1 obtained as above is represented in hexadecimal form in such an order that the initial reference body corresponds to the lowest bit.

In accordance with the second embodiment of this invention, the description of the relative position of the reference bodies which compose a given object is simple and no advanced knowledge is required to reproduce the shape of the object by folding the chain of the reference bodies according to the sequence of 0 and 1 which represents the shape. Each reference body is composed of such four identical isosceles triangles that the ratio of length of its sides is 2:sqrt (3):sqrt (3). And the sequence of 0 and 1 is obtained by assigning the values of 0 and 1 to the two faces of a reference body which can be contacted with the corresponding face of the following reference body, one pair at a time, by rotation around the longer edge shared by the two reference bodies.

### BRIEF DESCRIPTION OF THE DRAWING

The forgoing and other objects of this invention, the various features there of, as well as the invention itself, will be more fully understand from the following description, when read together with the accompanying drawing in which:

FIG. 1 shows the composition of a shape processing system 100 embodying the first embodiment of this invention;

FIG. 2 shows the composition of a shape processing unit 200 embodying the first embodiment;

FIG. 3 shows the flow-chart of the imitation (or approximation) procedure done by the shape processing unit 200;

FIG. 4 shows the flow-chart of the reproducing procedure done by the shape processing unit 200;

FIG. 5 illustrates the reproducing procedure done by the shape processing unit 200;

FIG. 6 is a side view of a helical structure reproduced by the shape processing unit 200;

FIG. 7 is a side view of a double helical structure reproduced by the shape processing unit 200;

FIG. 8 illustrates the putting of a first side of a first reference body 3 on a second side of a second reference body 4 by the approximating unit 240 of the shape processing unit 200;

FIG. 9 is a perspective view of a series of reference bodies used by the approximating unit 240 of the shape processing unit 200;

FIG. 10 illustrates face setting information recorded by the approximation information storage unit 220 of the shape processing unit 200;

FIG. 11 is a perspective view of a rhombic dodecahedron reproduced using a series of twenty-four reference bodies by the approximating unit 240 of the shape processing unit 200;

FIG. 12 is a figure that illustrates the imitation (approximation) and reproducing procedure of the second embodiment;

FIG. 13 is the code table used in the procedure of the second embodiment;

FIG. 14 is a sequence of 0 and 1 produced by the procedure of the second embodiment;

FIG. 15 illustrates steps executed by the reproducing procedure of the second embodiment;

FIG. 16 shows a figure reproduced by the reproducing procedure of the second embodiment;

FIG. 17 is a figure drawn by a broken line obtained by the conventional polygon-mesh method;

FIG. 18 is a figure of a polygon drawn by a broken line consisted of ten segments;

FIG. 19 is a table that gives the coordinates of the vertices of a polygon of FIG. 18;

FIG. 20 shows the four reference blocks used to illustrate the CSG method;

FIG. 21 is a division of the figure of FIG. 17 into six basic blocks;

FIG. 22 is a table of nodes used to illustrate the CSG method;

FIG. 23 shows the figures obtained during the process of the CSG method;

FIG. 24 is a figure used to illustrate the marching pattern method;

FIG. 25 is a table that gives coordinates and topological information of the vertices of a figure of FIG. 24;

FIG. 26 is a figure obtained by changing topological information of t3 in the table given in FIG. 25 from 1 to 0.

### DETAILED DESCRIPTION OF THE INVENTION

In the following several embodiments of this invention are illustrated using the accompanying figures.

### The First Embodiment

The first embodiment of this invention generates a series of such reference bodies as tetrahedrons which consist of four identical faces. The series is generated by putting a face of a reference body on a face of another reference body repeatedly and we imitate the shape of an object in three-dimensional space using the series.

The first embodiment stores approximation information that represents the pairs of faces of consecutive reference bodies which are contacted at the connections of a series in the same order as the connections in a linear list. And the first embodiment reproduces the shape of a three-dimensional object using the information.

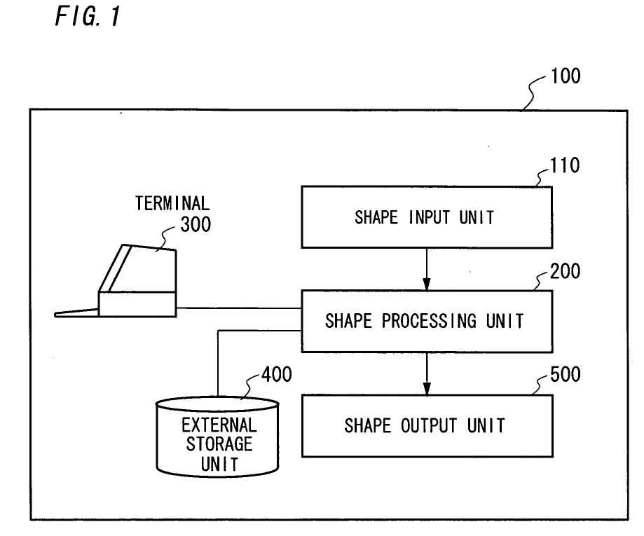

FIG. 1 shows the composition of a shape processing system 100 embodying the first embodiment of this invention. The shape processing system 100 comprises a shape input unit 110, a shape processing unit 200, a terminal 300, an external storage unit 400, and a shape output unit 500.

The shape input unit 110 receives input data of the shape of an object in a three-dimensional space, and the shape processing unit 200 converts the data into digital data for manipulations by computers and conveys the digital data to the shape output unit 500.

The shape processing unit 200 imitates the shape of the object using the digital data of the shape and reference information about reference bodies which are tetrahedrons, and stores approximation information obtained in an internal memory (not shown in FIG. 1) or an external memory 400.

And the shape processing unit 200 reproduces the input data of the shape of the object using approximation information stored in the internal or external memory 400 and reference information.

The terminal orders the shape processing unit 200 to imitate or reproduce the shape of an object under directions from a user of the shape processing system 100.

The external memory 400 may also store reference information required to imitate the shape of an object by the shape processing unit 200 or a program which implement the functions of the shape processing unit 200 as well as approximation information generated by the shape processing unit 200.

The shape output unit 500 outputs the shape of an object reproduced by the shape processing unit 200.

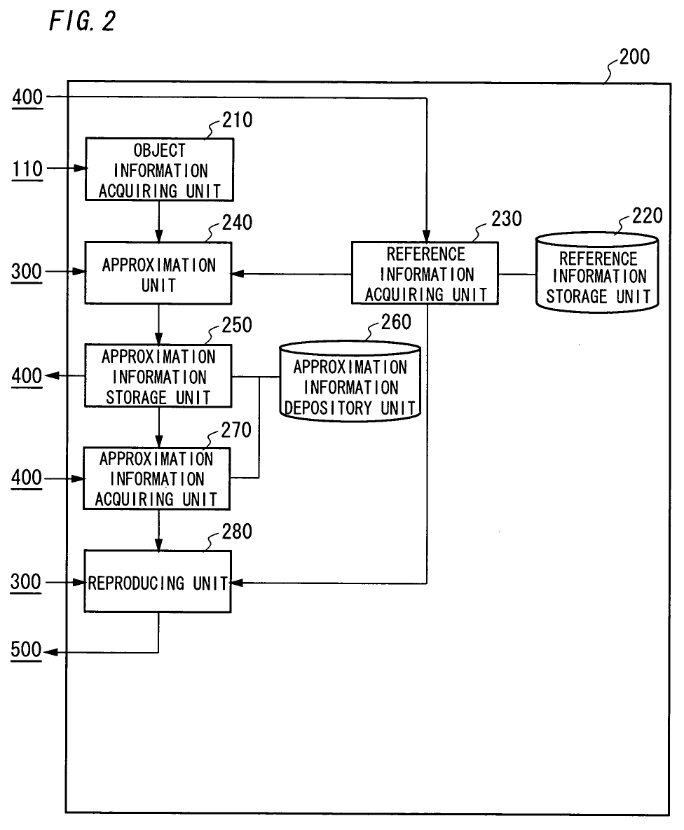

FIG. 2 shows the composition of the shape processing unit 200 embodying the first embodiment. The shape processing unit 200 comprises an object information acquiring unit 210, a reference information storage unit 220, a reference information acquiring unit 230, an approximation unit 240, an approximation information storage unit 250, an approximation information depository unit 260, an approximation information acquiring unit 270, and a reproducing unit 280.

The object information acquiring unit 210 acquires the information of the shape of an object from the shape input unit 110 and conveys it to the approximation unit 240.

The reference information storage unit 220 stores reference information required to imitate or reproduce the shape of an object. Reference information contains reference body information that specifies the shape of reference bodies.

The reference information acquiring unit 230 acquires reference information from the reference information storage unit 220 and conveys it to the approximation unit 240. The reference information acquiring unit 230 may acquire reference information from the external storage unit 400 if the external storage unit 400 has the information.

The approximation unit 240 generates approximation information by approximating the shape of an object using the information conveyed from the shape input unit 110 that represents the shape of the object and reference information conveyed from the reference information acquiring unit 230.

The approximation information storage unit 250 store approximation information in the approximation information depository unit 260 or the external storage unit 400.

When approximation information is stored in the external storage unit 400, another shape processing system can reproduce the shape of the object using the same external storage unit 400.

The approximation information acquiring unit 270 acquires approximation information from the approximation information depository unit 260 or the external storage unit 400 and conveys it to the reproducing unit 280.

The reproducing unit 280 reproduces the shape of the object using approximation information conveyed from the approximation information acquiring unit 270 and reference information conveyed from the reference information acquiring unit 230 and convey reproduction information to the output unit 500.

As is show above, since the approximation unit 240 imitates the shape of an object using reference information stored in the reference information storage unit 220 or the external storage unit 400, there is no need to renew reference information for each case of imitation (or approximation) and it simplifies the process of imitation (or approximation).

Since the reproducing unit 280 uses reference information stored in the reference information storage unit 220 or the external storage unit 400 as the approximation unit 240 does, it is also possible to simplify the process of reproduction.

And it is possible for the approximation unit 240 and the reproducing unit 280 to share reference information since they use the same information.

Moreover, when external storage unit 400 contains approximation information of the shape of an object generated by another system, the shape processing system 100 can reproduce the shape by getting the approximation information storage unit 250 to acquire approximation information from the external storage unit 400.

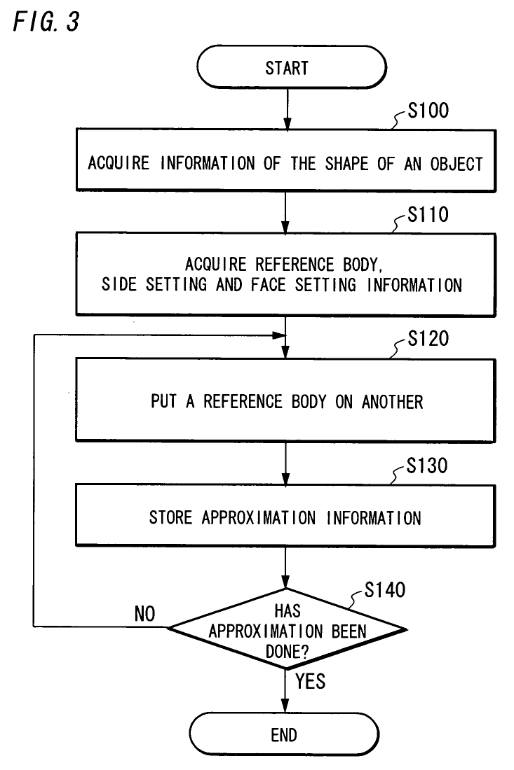

FIG. 3 shows the flow-chart of the imitation procedure executed by the shape processing unit 200.

First, the object information acquiring unit 210 acquires information which represents the shape of an object from the shape input unit 110 (step S100).

Next, the reference information storage unit 220 acquires reference information, that is, reference body information, side setting information, and face setting information (step S110). Reference body information specifies the shape of a reference body which is a tetrahedron consisted of four identical faces. Side setting information specifies two side of a reference body which are in a twisted position and records them as the first and the second side of the reference body. Face setting information specifies two faces of a reference body which share the first side of the reference body and records them as the first and the second face of the reference body.

The approximation unit 240 generates a chain of two reference bodies by putting a reference body on another (step S120). In details, the approximation unit 240 puts the first side of a reference body on the second side of another. Then the approximation unit 240 firstly imitates the shape of an object by putting the first face of a reference body on the corresponding face of another. Secondly it imitates the shape by putting the second face of a reference body on the corresponding face of another. And finally it decides which one gives the better imitation of the shape.

The approximation unit 240 executes the better one by putting the first or second face of a reference body on the corresponding face of another. In some cases, the approximation unit 240 may be interfered with a user of the terminal 300 to decide which imitation to execute.

Then the approximation information storage unit 250 stores approximation information that represents which of the first and second face of the first reference body is put on the corresponding face of the second reference body in the approximation information depository unit 260 or the external memory 400 (step S130).

The shape processing unit 200 decides whether imitation (approximation) of the shape of the given object has been done or not (S140). In details, the shape processing unit 200 judges whether the difference between the shape of the object and the shape generated by a chain of reference bodies is minimized or not. If the difference is minimized, the shape processing unit 200 concludes that imitation has been done successfully. If not, the shape processing unit 200 concludes that imitation has not been done yet.

If imitation of the shape of the given object is concluded not to be completed yet at step S140, the shape processing unit 200 executes the step S120 again. If imitation is concluded to be completed, the shape processing unit 200 finishes the imitation process.

The approximation unit 240 imitates the shape of the given object using a chain of reference bodies generated by repeated execution of the step S120.

The approximation information storage unit 250 stores approximation information of reference bodies of the chain by repeated execution of the step S130 in such an order that they appear in the chain.

As shown above, all what the approximation unit 240 does in the process is to put the first or second face of a reference body on the corresponding face of another reference body. Therefore, by denoting the first face of a reference body by “0” and the second face by “1”, one can instructs the approximation unit 240 what to do using a value of 0 or 1. That is, one can instructs the approximation unit 240 what to do using a sequence of 0 and 1 and, as an output, obtains a chain of reference bodies which imitates the shape of the given object. When the approximation unit 240 is interfered with a user of the terminal 300, the user inputs a value “0” or “1” to chose one of the first and second face of a reference body to put.

Therefore, by denoting the first face of a reference body by “0” and the second face by “1”, approximation information is represented by a sequence of 0 and 1. And it reduces the amount of data to be recorded in the approximation information depository unit 260 or the external memory 400.

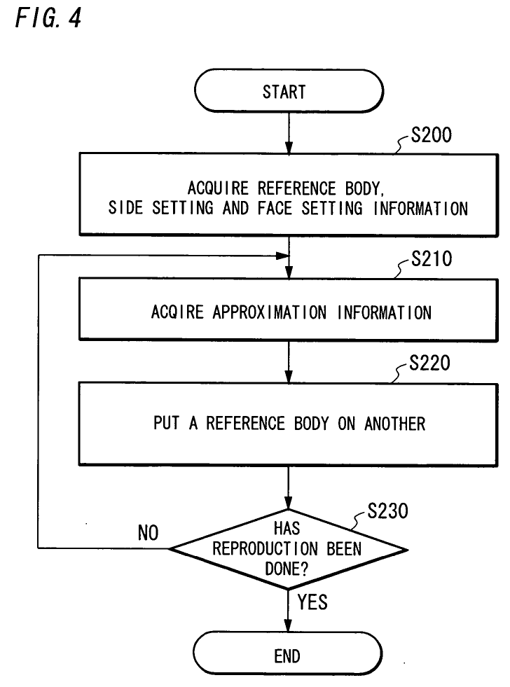

FIG. 4 shows the flow-chart of the reproducing procedure executed by the shape processing unit 200.

First, the reference information acquiring unit 230 acquires reference information such as reference body information, side setting information and face setting information (step S200).

Next, the approximation information acquiring unit 270 acquires approximation information from the approximation information depository unit 260 or the external storage unit 400 (step S210). Here, for example, approximation information consists of a sequence of 0 and 1 as shown in FIG. 3.

Then the reproducing unit 280 generates a chain of two reference bodies as follows. The unit 280 firstly puts the first side of the first reference body on the second side of the second reference body. And secondly the unit 280 puts either the first or second face of the first reference body on the corresponding face of the second reference body, according to the approximation information acquired (step S220).

The shape processing unit 200 judges whether the reproduction of the shape of the given object has been completed or not. If the reproduction has not been completed yet, the shape processing unit 200 execute the step S210 again. If the reproduction has been completed, the shape processing unit 200 finishes the reproduction process.

By repeating the step S210, the reproducing unit 280 gets approximation information of reference bodies of a chain from the approximation information acquiring unit 270 in the order that the chain is generated. And the reproducing unit 280 generates the chain of reference bodies to reproduces the shape of the given object.

As is shown above, the reproducing unit 280 as well as the approximation unit 240 can reproduces the putting of a reference body on another reference body using 0 and 1 as approximation information.

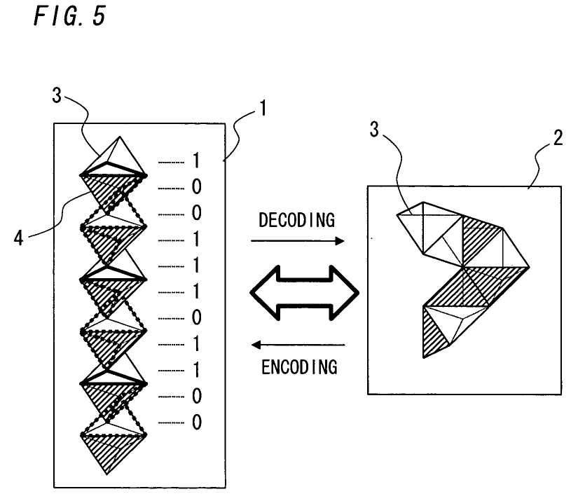

FIG. 5 illustrates the reproducing procedure executed by the shape processing unit 200. In the figure, 1 shows a chain of reference bodies. Every reference body which is a tetrahedron of the chain 1 except the last one is assigned a value of 0 or 1 by the approximation information depository unit 260. In the example, the reference body 3 at the top is assigned the value of 1 and the second reference body 4 is assigned the value of 0. By folding the chain 1 under the instructions given by the sequence of 0 and 1, the shape 2 is obtained (In this case, as shown in the following, the value assigned to a reference body denotes the face of the reference body enclosed by a bold line.).

If one arrange the sequence of 0 and 1 in such an order that the starting tetrahedron corresponds to the lowest bit, then the sequence is represented by 1B9 in hexadecimal form (i.e., 001 1011 1001 in binary form). That is, the specification of folding to obtain the shape 2 in FIG. 5 is represented by a number 1B9. Or equivalently, once a number which represents a folding to obtain a shape is recorded, one can reproduce the shape from the number.

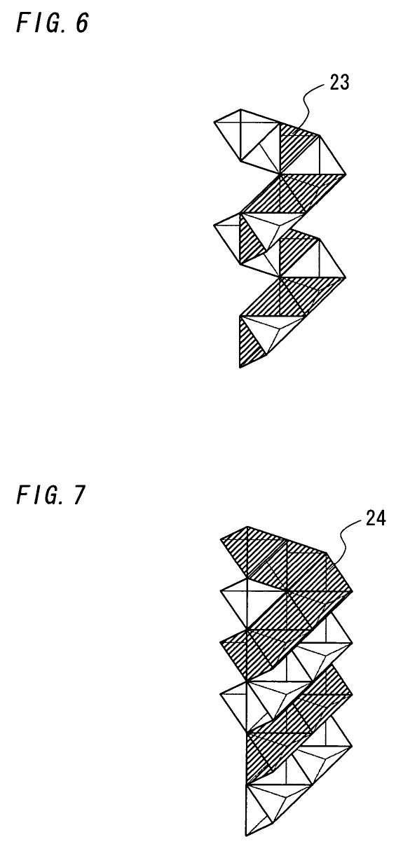

FIG. 6 is a side view of a helical structure reproduced by the shape processing unit 200. By connecting two copies of the shape 2 in FIG. 5, one can obtain the helical structure 23 shown in FIG. 6.

FIG. 7 is a side view of a double helical structure reproduced by the shape processing unit 200. The double helical structure 24 consists of two copies of the helical structure 23. In the filed of life science it is known that a DNA molecule forms such a shape as the double helical structure 24 and the structure is one of the meaningful shapes in nature.

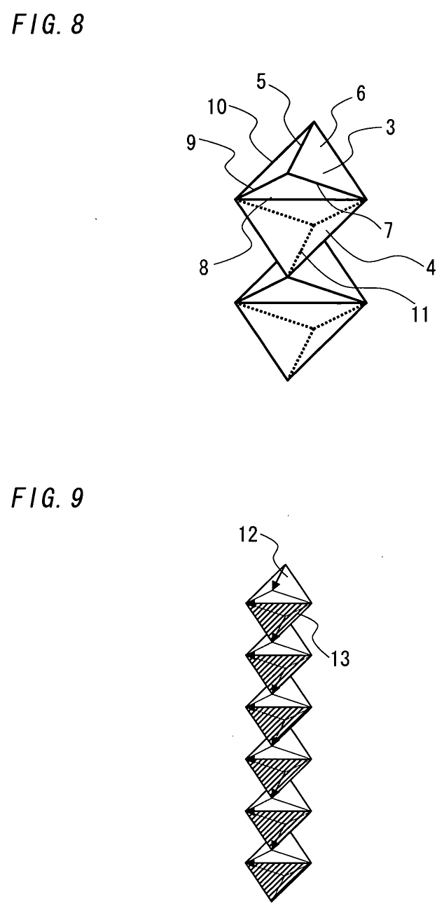

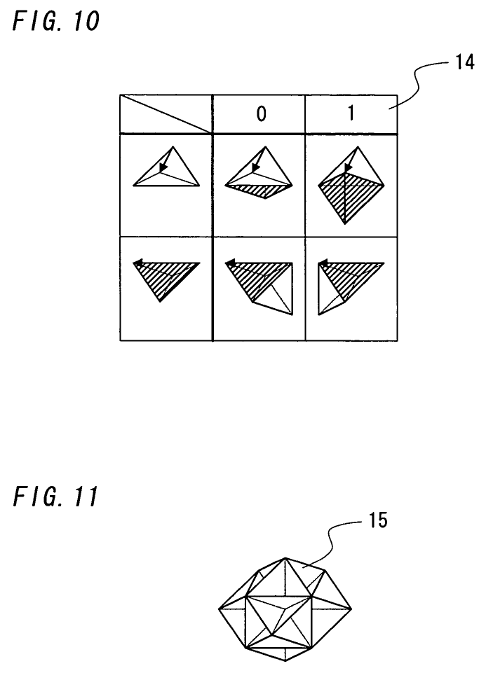

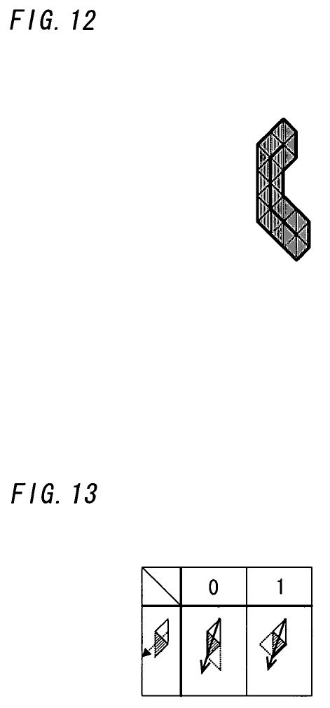

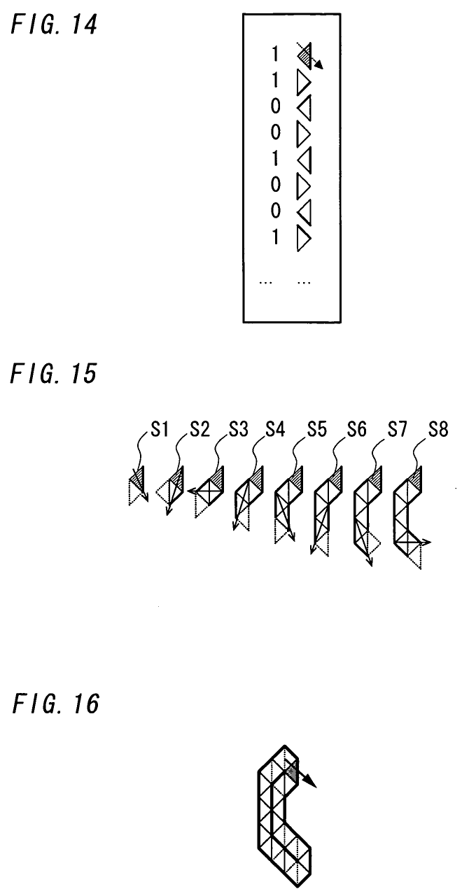

FIG. 8 illustrates the putting of a first side of a first reference body 3 on a second side of a second reference body 4 by the approximating unit 240 of the shape processing unit 200. The reference body 3 in FIG. 8 consists of such four triangles that the ratio of length of the sides is 2:sqrt (3):sqrt (3). In the case of this reference body 3, the sides of 6, 7, 9 and 10 are shorter and the sides of 5 and 8 are longer. The following reference body 4 is put or connected with reference body 3 on the longer side 8.

At the connection, two reference bodies which share the longer side 8 can be brought into contact with each other in a face by rotation around the side 8. And it is also possible to fasten them in the position.

Note that there are two ways to bring the reference body 3 into contact with the reference body 4 in a face. One is to bring the face of this side of the reference body 3 into contact with the face of this side of the reference body 4. The other one is the face of the opposite side of the reference body 3 into contact with the face of the opposite side of the reference body 4.

A reference body is put or connected with another on the longer side 8 so as to implement the both ways of contact.

In the same way, the reference body 4 is brought into contact with another reference body on the side 11. Repeating this process, one can connect any number of reference bodies sequentially. In this way such a chain 1 of reference bodies that every pair of consecutive reference bodies share a longer side is obtained.

The shape reproduced by a chain of reference bodies is determined by the pairs of faces contacted at each connection. We call the process of fastening those faces in the position “folding of the chain”. By folding a chain, one obtains the corresponding shape.

In this embodiment, the reference body 3 consists of such four identical triangles that the ratio of length of the sides is 2:sqrt (3):sqrt (3). One may also use another reference body which consists of four triangles such as equilateral triangles or triangles which are not isosceles. But the tetrahedrons which consist of such four identical triangles that the ratio of length the sides is 2:sqrt (3):sqrt (3) can be fitted together to fill a three-dimensional space without overlaps and gaps (G. Nakamura, sinsho-427 ‘Mathematical puzzles’, Chuo Kouron-sha, 1976). This fact make this embodiment preferable.

FIG. 9 and FIG. 10 illustrate face setting information recorded by the approximation information storage unit 220 of the shape processing unit 200.

FIG. 9 is a perspective view of a chain of reference bodies generated by the approximating unit 240 by putting the first side of a reference body on the second side of another reference body using reference body information and side setting information. Note that what the approximation information storage unit 220 records when it stores reference body information and side setting information is nothing but the chain of reference bodies shown in FIG. 9. Using the chain recorded in the approximation information storage unit 220 and face setting information, the approximating unit 240 puts the first or second face of a reference body on the corresponding face of the following reference body. In the following we explain this process in detail.

When the approximation information storage unit 220 records face setting information, it divides the reference bodies of a chain into type W (white as 12 in FIG. 9) and type B (black as 13 in FIG. 9). Using the coding table of FIG. 10, the approximation information storage unit 220 records a value 0 or 1 as face setting information which represents the face of contact between a W type reference body 12 and the following reference body or between a B type 13 reference body and the following reference body. At the lowest end the approximation information storage unit 220 does not records face setting information since there follows no reference body.

The sequence of 0 and 1 obtained this way is arranged in such an order that the top reference body corresponds to the lowest bit. And the sequence is represented in hexadecimal form to denote the folding of a chain.

FIG. 11 is a perspective view of a rhombic dodecahedron reproduced using a chain of twenty-four reference bodies by the approximating unit 240 of the shape processing unit 200. The rhombic tetrahedron 15 shown in FIG. 11 is reproduced by the approximating unit 240 using a chain of twenty-four reference bodies.

Then the approximation information storage unit 250 records as approximation information a hexadecimal number 414141 (100 0001 0100 0001 0100 0001 in binary form) which represents the folding of the rhombic tetrahedron 15.

Using the approximation information, the reproducing unit 280 reproduces the rhombic tetrahedron 15 from a chain of twenty-four reference bodies.

Tetrahedrons used as reference bodies in this embodiment are not restricted to actual tetrahedrons that have sides and faces. They may be such objects that have four points which correspond to the four corners of a tetrahedron in a three-dimensional space In particular, they may have no actual sides or faces. In that case, a side means a pair of points which corresponds to a side of a tetrahedron and a face means a triplet of points which corresponds to a face of a tetrahedron.

Moreover, the reference bodies in this embodiment may not have the appearance of tetrahedrons. In other words, it is enough for the reference bodies to specify the shape of tetrahedrons. For example, a tetrahedron is specified by information of the position of two segments in a twisted position. In this case, the first face corresponds to the triangle specified by the first segment and an endpoint of the second segment and the second face corresponds to the triangle specified by the first segment and the other endpoint of the second segment.

As another example, the reference bodies in this embodiment maybe represented by pairs of points. It is preferred that one of the two points in a pair corresponds the middle point of the first side of a tetrahedron and the other point corresponds to the middle point of the second side of the tetrahedron.

In this case putting of the first point of a reference body on the second point of another reference body corresponds to putting of the first side of a reference body on the second side of another reference body. And setting the segment spanned by the first and second point of a reference body to be perpendicular to the segment spanned by the first and second point of another reference body corresponds to putting the first or second face of a reference body on the corresponding face of another reference body.

### The Second Embodiment

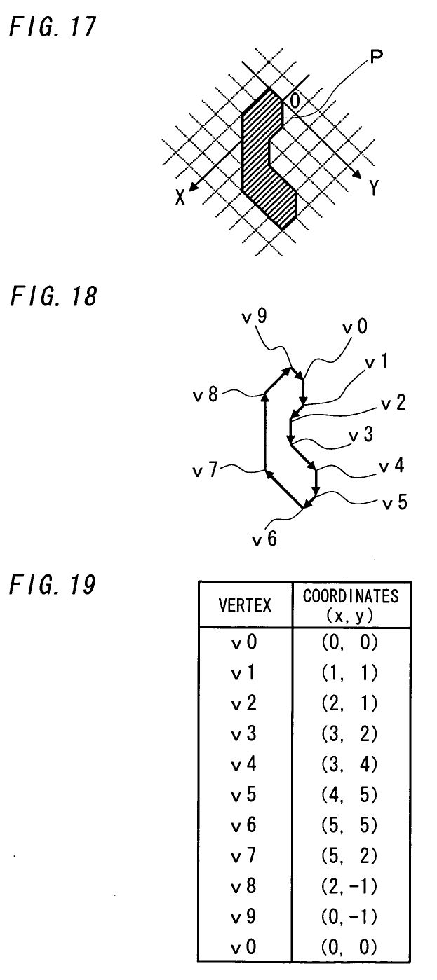

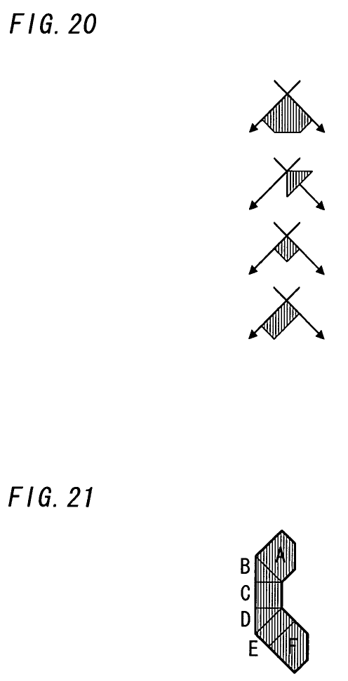

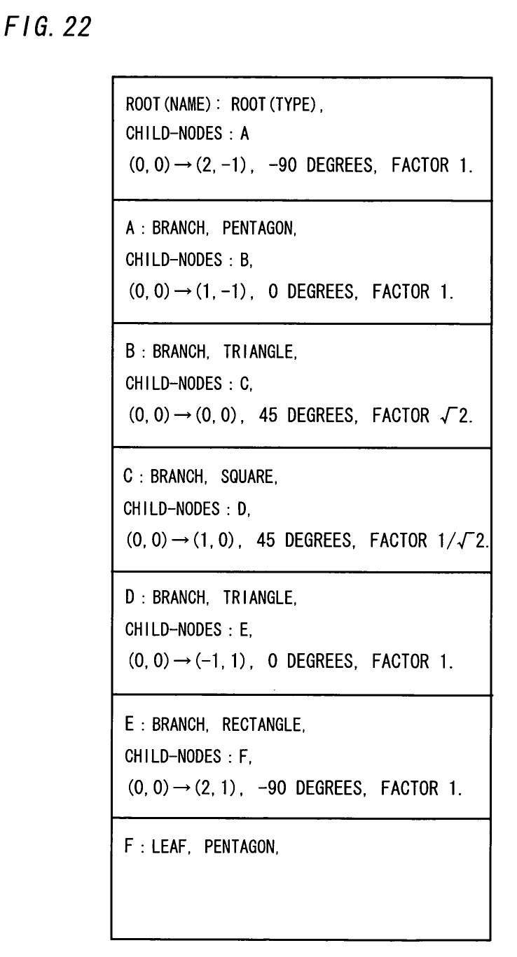

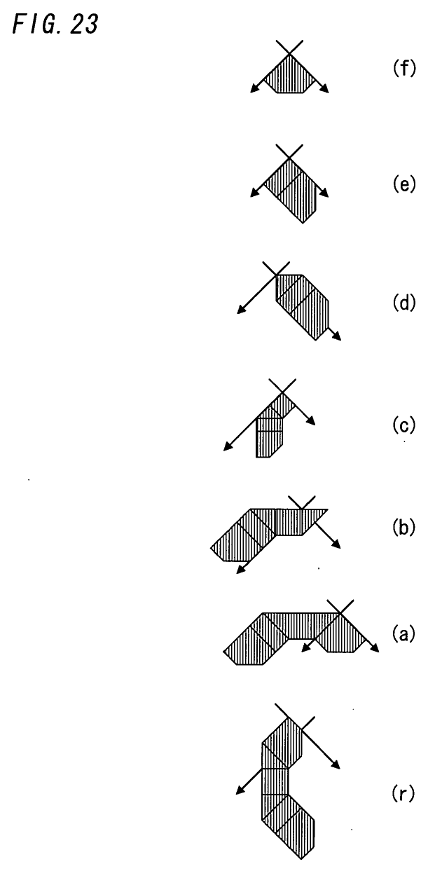

FIG. 23 is a figure that illustrates the imitation (or approximation) and reproduction procedure of the second embodiment. The figure shown in FIG. 23 is identical with the figure P in FIG. 17. As in the same way as the case of the shapes of three-dimensional objects, the figure is reproduced by a series of reference bodies. Note that the reference body is a triangle in this case since the figure is two-dimensional.

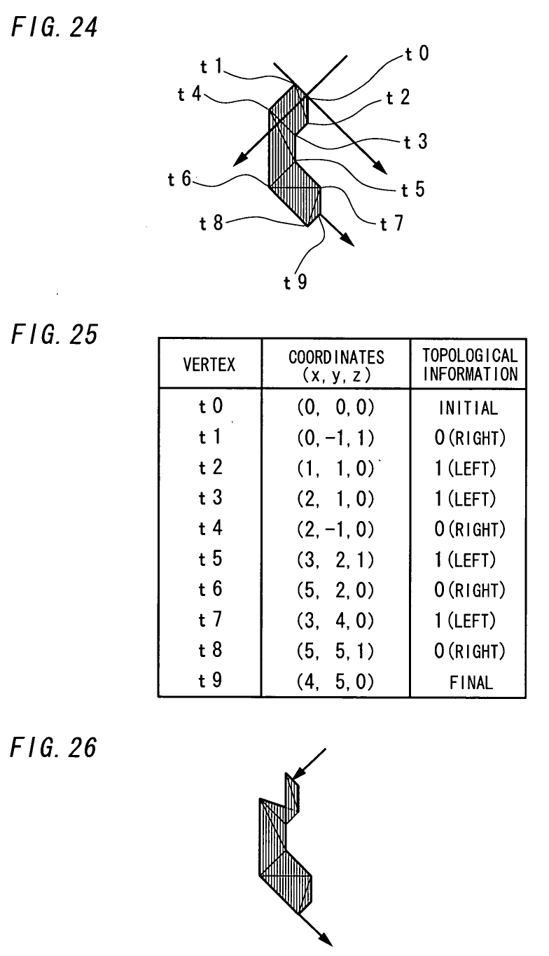

FIG. 24 is the code table used in the procedure of the second embodiment. In this embodiment, the figure P in FIG. 28 is represented by a chain of twenty-six triangles as is shown in FIG. 23. The folding of the chain is encoded into a sequence of 0 and 1 using the table of FIG. 24.

The table shows the encoding rule in the case when one move from the white triangle with a valid outline to the gray triangle and it encodes one of the two triangles with a dotted outline where one will proceed (Note that the arrows in the table denote the direction to proceed.). If one proceeds to the left triangle, the value of 0 is assigned to the gray triangle. If one proceeds to the right triangle, the value of 1 is assigned to the gray triangle. The assigned information of the gray triangle corresponds to the face setting information stored by a reference information storage unit 220 in the first embodiment of this invention.

Using the table of FIG. 24, the figure in FIG. 23 is encoded into such a sequence of 0 and 1 that 1 0110 1011 0101 1110 1001 0011.

The sequence corresponds to approximation information stored by an approximation information storage unit 250 in the first embodiment. 0s and 1s in the sequence are arranged in such an order that the initial triangle corresponds to the right most place. And the sequence is expressed by 16B5E93 in hexadecimal form.

FIG. 25 is a sequence of 0 and 1 produced by the procedure of the second embodiment. The upper most value in FIG. 25 corresponds to the right most place of the sequence above. The sequence corresponds to approximation information acquired by an approximation information acquiring unit 270 in the first embodiment.

FIG. 26 illustrates steps executed by the reproducing procedure of the second embodiment. It shows the folding of a series of triangles specified by the sequence in FIG. 25. First, one proceeds to the right triangle in step S1 since the code of the initial triangle is 1. In step S2, one proceeds to the right since the code of the second triangle is also 1. In step S3, one proceeds to the left since the code of the third triangle is 0. Continuing the steps, one obtains a figure encoded by the sequence of 0 and 1. This process corresponds to the reproducing process executed by a reproducing unit 280 in the first embodiment. FIG. 27 shows a figure reproduced by the reproducing procedure of the second embodiment.

In this way, the figure P in FIG. 28 is expressed by a sequence of 0 and 1, i.e., a simple data set without any internal structure. In the case of three-dimensional objects, the shape of a object is expressed by a sequence of 0 and 1 using a chain of tetrahedrons, each of which consists of such four identical triangles that the ratio of length of the sides is 2:sqrt (3):sqrt (3). Tetrahedrons are connected each other on the longer edges. And the coding rule is given by the table in FIG. 10.

In particular, this embodiment enables one to express the shape of a three-dimensional object without using Cartesian coordinates in three-dimensions. Moreover one can express it by a simple data set such as a sequence of 0 and 1 unlike conventional methods which use a complex data structure such as trees. That is, by limiting the topological relationship among reference bodies to a chain, the description of relative position of the reference bodies is simplified and one can encode a shape into a simple sequence of 0 and 1 without any advanced knowledge.

As explained above in details, one can reproduce the shape of an object in a three-dimensional space from a sequence of 0 and 1 using a chain of tetrahedrons, each of which consists of such four identical triangles that the ratio of length of the sides is 2:sqrt (3):sqrt (3) and is connected each other on the longer edges. The sequence of 0 and 1 is obtained by assigning a value of 0 or 1 to each tetrahedron of the chain which represents the face of a tetrahedron where the tetrahedron contacts with the following tetrahedron. Because of the simple topology of a chain, one can reproduce the shape from the sequence of 0 and 1 without any advanced knowledge.

While the foregoing has described what are at present considered to be the preferred embodiments of this invention, the scope of the invention is not limited by the embodiments. And it will be apparent that various modifications and other embodiments within the invention occur to those skilled in the art.

### Industrial Applicability

It is apparent from the foregoing description that the invention provides us a shape processor and a program which imitate and reproduce the shape of an object and a three-dimensional shape encoding method, such that they enable us to express the shape of an object in a three-dimensional space without using Cartesian coordinates in three-dimensions, using a simple data set such as a sequence of 0 and 1 by limiting the topological relation among parts of the object, and the shape is reproduced from the sequence of 0 and 1 without any advanced knowledge.

What is claimed is:

1. A shape processor for imitating the shape of an object in a three-dimensional space, the shape processor comprising:
a reference information acquiring unit for acquiring reference body information for specifying the shape of a reference body which is a tetrahedron composed of four identical faces, side setting information for setting two sides of said reference body in a twisted position as first and second sides, and face setting information for setting two faces sharing said first side of said reference body as first and second faces;
an approximating unit for imitating the shape of an object using said reference bodies, by putting said first side of said first reference body on said second side of said second reference body and putting either said first or second face of said first reference body on the corresponding face of said second reference body, according to the information representing the shape of the object and the information acquired by said reference information acquiring unit; and
an approximation information storage unit for storing approximation information representing which of said first and second faces of said first reference body is put on the corresponding face of said second reference body.

2. A shape processor for reproducing the shape of an object in a three-dimensional space, the shape processor comprising:
a reference information acquiring unit for acquiring reference body information for specifying the shape of a reference body which is a tetrahedron composed of four identical faces, side setting information for setting two sides of said reference body in a twisted position as first and second sides, and face setting information for setting two faces sharing said first side of said reference body as first and second faces;
an approximation information storage unit for acquiring approximation information representing which of said first and second faces of said first reference body is put on the corresponding face of said second reference body; and
and an reproducing unit for reproducing the shape of an object using reference bodies by putting said first side of said first reference body on said second side of said second reference body and putting either said first or second face of said first reference body on the corresponding face of said second reference body, according to the information acquired by said reference information acquiring unit and the approximation information acquired by said approximation information storage unit.

3. A shape processor as claimed in claim 1, wherein said reference information acquiring unit acquires reference body information which specifies a tetrahedron composed of such four identical isosceles triangles that the ratio of length of its sides is 2:sqrt (3):sqrt (3).

4. A shape processor as claimed in claim 2, wherein said reference information acquiring unit acquires reference body information which specifies a tetrahedron composed of such four identical isosceles triangles that the ratio of length of its sides is 2:sqrt (3):sqrt (3).

5. A shape processing program for imitating the shape of an object in a three-dimensional space, the shape processing program comprising:
a reference information acquiring module for acquiring reference body information for specifying the shape of a reference body which is a tetrahedron composed of four identical faces, side setting information for setting two sides of said reference body in a twisted position as first and second sides, and face setting information for setting two faces sharing said first side of said reference body as first and second faces;
an approximating module for imitating the shape of an object using said reference bodies by putting said first side of said first reference body on said second side of said second reference body and putting either said first or second face of said first reference body on the corresponding face of said second reference body, according to the information representing the shape of the object and the information acquired by said reference information acquiring module; and
an approximation information storage module for storing approximation information representing which of said first and second faces of said first reference body is put on the corresponding face of said second reference body.

6. A shape processing program for reproducing the shape of an object in a three-dimensional space, the shape processing program comprising:
a reference information acquiring module for acquiring reference body information for specifying the shape of a reference body which is a tetrahedron composed of four identical faces, side setting information for setting two sides of said reference body in a twisted position as first and second sides, and face setting information for setting two faces sharing said first side of said reference body as first and second faces;
an approximation information storage module for acquiring approximation information representing which of said first and second faces of said first reference body is put on the corresponding face of said second reference body; and
an reproducing module for reproducing the shape of an object using reference bodies by putting said first side of said first reference body on said second side of said second reference body and putting either said first or second face of said first reference body on the corresponding face of said second reference body, according to the information acquired by said reference information acquiring module and the approximation information acquired by said approximation information storage module.

7. A shape encoding method which encodes the shape of a given object in a three-dimensional space by representing the relation among reference bodies obtained by dividing the object, the method comprising steps of:
encoding the shape into a sequence of 0 and 1 using reference bodies where each reference body is a tetrahedron composed of such four identical isosceles triangles that the ratio of length of its sides is 2:sqrt (3):sqrt (3);
connecting each reference body with another one or two reference bodies to form a chain at the longer edges in such a way that two faces of a reference body can be brought into contact with the corresponding faces of the following reference body, one pair at a time, by rotation around the longer edge shared by the two reference bodies;
encoding the shape by specifying the folding of the chain, i.e., the folding at each longer edge between two consecutive reference bodies in said chain;
assigning the values of 0 and 1 to the two faces of said reference body which share a longer edge, 0 for a face and 1 for the other, in advance; and
using the values to describe the folding at the longer edges, that is, which face of said reference body is in contact with the corresponding face of said following reference body.
